(19) United States
(12) Patent Application Publication
(10) Pub. No.: US 2023/0127589 A1
(43) Pub. Date: Apr. 27, 2023

(54) REAL-TIME VIDEO OVERLAYING AND SHARING

(71) Applicant: Loop Now Technologies, Inc., San Mateo, CA (US)

(72) Inventors: Wu-Hsi Li, Somerville, MA (US); Ting Kwan Luk, Menlo Park, CA (US); Li Chen, San Jose, CA (US); Yang-Cheng Fan, San Jose, CA (US); Xinshuo Zhang, Falcon Heights, MN (US)

(21) Appl. No.: 18/075,543

(22) Filed: Dec. 6, 2022

Related U.S. Application Data
(63) Continuation-in-part of application No. 17/548,569, filed on Dec. 12, 2021.
Application No. 17/548,569 is a division of application No. 16/839,081, filed on Apr. 3, 2020, now Pat. No. 11,223,855.
(60) Provisional application No. 62/902,361, filed on Sep. 18, 2019.

(51) Int. Cl. H04N 21/234; H04N 5/272; H04N 21/2187; H04N 23/90

(52) U.S. Cl. CPC H04N 21/23424; H04N 5/272; H04N 21/2187; H04N 23/90

(57) ABSTRACT

Technologies relating to a system and method of real-time video overlaying and sharing from multiple cameras are disclosed. An example method of real-time video overlaying and sharing includes the steps of: capturing video output from a first camera on a mobile device, recognizing a portion of an individual in the captured video output and determining a user body contour, generating a binary mask, enabling real-time video processing, including the separate user body contour from a background of the video from the first camera, smoothing one or more edges of the binary mask, merging the binary mask with the video from the first camera, and creating a composite video, merged from the first camera video output onto a second camera video output. The second camera can be included on the same mobile device as the first camera, facing in the opposite direction, or on a second mobile device.

### CROSS-REFERENCE TO RELATED APPLICATION

The present application is a continuation-in-part application of U.S. patent application “System And Method of Real-Time Video Overlaying or Superimposing Display”, Ser. No. 17/548,569, filed on Dec. 12, 2021, which is a divisional application of U.S. patent application “System And Method of Real-Time Video Overlaying or Superimposing Display”, Ser. No. 16/839,081, filed on Apr. 3, 2020, which claims the benefit of U.S. provisional application “Method of Real-Time Video Overlaying and Superimposing Display from Multiple Mutually-Synchronous Cameras”, Ser. No. 62/902,361, filed on Sep. 18, 2019. Each of the foregoing applications is hereby incorporated by reference in its entirety.

### TECHNICAL FIELD

The present disclosure relates generally to real-time video overlaying and sharing video output and more specifically real-time video overlaying and sharing video output from multiple mutually synchronous cameras.

### BACKGROUND

A longstanding adage dating back hundreds of years is “A picture is worth a thousand words.” The idea expressed by this truism has been attributed to sources including Henrik Ibsen, Fred Barnard, Leonardo da Vinci, Napoleon Bonaparte, and even Confucius. Regardless of the source, the observation that complex and sometimes multiple ideas can be communicated by images more effectively than with verbal descriptions alone has been validated many times in our society. As printing quality progressed, the inclusion of illustrations and photographs along with print in books, magazines, journals, and newspapers enhanced the ability to tell a story more effectively. As film, television, and video have become more prevalent, the truth of the adage has become even more apparent. The Warren Commission published an 888-page written report along with 15 volumes of hearings and 11 volumes of evidence, totaling 50,000 pages of detailed information. Their conclusion was that Lee Harvey Oswald acted alone to assassinate President John F. Kennedy. Nevertheless, nearly two-thirds of the country believe that Oswald was part of a larger conspiracy. One of the principal reasons for this belief is the film made by Abraham Zapruder which captured the moment of impact by the third bullet striking the President. Oliver Stone famously summarized the conclusion of many who have viewed the Zapruder film as showing the impact of the third bullet moving Kennedy's head “back and to the left”, meaning the shot must have come from in front of the President's motorcade, and to its right, not from behind. For many, the power of the images captured by the Zapruder film eclipse the many thousands of words written by the Warren Commission. This can be especially true when the images are combined with simultaneously spoken words. Live demonstrations, television commercials, boardroom presentations, and many other occasions for communication all merge pictures with spoken and written words. In general, the more layers of communication that can be delivered simultaneously, the more effectively the message can be conveyed. As media forms and technologies have grown, the ability to link images with words continues to expand. Rapid distribution of short-form videos has allowed demonstrations of all sorts of skills, from cooking a soufflé to riding a camel. Media influencers livestream their use of products and performances of art, music, dance, etc. Childbirth can be reported by a family member in real time. Image and video searches are becoming more and more preferred as the method for looking up information online. Nearly every part of our lives can be captured and narrated using a handheld device or stationary video camera. This trend is almost certain to continue as media technology expands and distribution methods improve. The moving picture, along with the spoken word, is indeed far more communicative to our society than the written word alone.

### SUMMARY

Technologies relating to real-time video overlaying and sharing video output are disclosed. Demand for combined video content has increased significantly, particularly for demonstrations, advertising, and influence marketing. Livestream and pre-recorded video content including streams from multiple cameras generated in real time can be a powerful tool in multiple forms of video presentation. Combined with ecommerce purchase options, real-time video overlaying and sharing can be an important avenue for attracting customers and closing sales.

A computer-implemented method for video content analysis is disclosed comprising: capturing video output from a first camera on a first mobile device; recognizing a portion of an individual in the video output that was captured, wherein the recognizing determines a user body contour; generating a binary mask, wherein the binary mask enables real-time video processing, which includes separating the user body contour from a background of the video output from the first camera; smoothing one or more edges of the binary mask; merging the binary mask with the video output from the first camera, wherein the merging produces a merged first camera output; and creating a composite video, wherein the merged first camera video output is overlaid onto a video output from a second camera. Other embodiments include a computer program product embodied in a non-transitory computer-readable medium for video content analysis, the computer program product comprising code which causes one or more processors to perform operations of: capturing video output from a first camera on a first mobile device; recognizing a portion of an individual in the video output that was captured, wherein the recognizing determines a user body contour; generating a binary mask, wherein the binary mask enables real-time video processing, which includes separating the user body contour from a background of the video output from the first camera; smoothing one or more edges of the binary mask; merging the binary mask with the video output from the first camera, wherein the merging produces a merged first camera output; and creating a composite video, wherein the merged first camera video output is overlaid onto a video output from a second camera.

In further embodiments, a computer system for video content analysis is provided comprising: a memory which stores instructions; one or more processors, attached to the memory wherein the one or more processors, when executing the instructions which are stored, are configured to: capture video output from a first camera on a first mobile device; recognize a portion of an individual in the video output that was captured, wherein the recognizing determines a user body contour; generate a binary mask, wherein the binary mask enables real-time video processing, which includes separating the user body contour from a background of the video output from the first camera; smooth one or more edges of the binary mask; merge the binary mask with the video output from the first camera, wherein the merging produces a merged first camera output; and create a composite video, wherein the merged first camera video output is overlaid onto a video output from a second camera.

### BRIEF DESCRIPTION OF THE DRAWINGS

FIG. 1 is a flow diagram for real-time video overlaying and sharing.

FIG. 2 is a flow diagram for binary mask manipulation.

FIG. 3 is an example real-time video overlaying system.

FIG. 4 is a flowchart illustrating a method of real-time video overlaying and superimposing.

FIG. 5 is a flowchart illustrating a method of real-time video overlaying and superimposing.

FIG. 6A is an exemplary image using model in accordance with some implementations of the present disclosure.

FIG. 6B is an exemplary image using a model in accordance with some implementations of the present disclosure.

FIG. 7 is an exemplary figure map with different rates.

FIG. 8 is an exemplary equation in accordance with implementations of the present disclosure.

FIG. 9 is an example real-time video overlaying system example.

FIG. 10A is an exemplary image illustrating a result of video overlaying system.

FIG. 10B is an exemplary image illustrating a result of video overlaying.

FIG. 11 is a picture-in-picture display example with real-time video overlaying.

FIG. 12 is an example of sharing with real-time video overlaying and sharing.

FIG. 13 is an example of a livestream with video output from a second camera on a second mobile device.

FIG. 14 is an infographic for an ecommerce checkout in a multi-host livestream.

FIG. 15 is a system diagram for overlaying.

The implementations disclosed herein are illustrated by way of example, and not by way of limitation, in the figures of the accompanying drawings. Reference numerals refer to corresponding parts throughout the drawings.

### DETAILED DESCRIPTION

Real-time video is more and more a part of our everyday lives. Since the days of live television in the 1940s and 50s, live broadcasting—analog or digital—has been attractive to both presenters and audiences alike. It allows viewers up-to-date information and accessible content. It gives presenters a higher level of engagement and interaction with their viewers. Today's livestreaming platforms have the highest rates of engagement of all product types. The fact that livestreaming occurs in real time brings a human element to the video experience. Things can go wrong and sometimes do. When a presenter makes a mistake, viewers can see and identify with them. A virtual relationship with the viewer is formed, which can be powerful in creating influence in marketing, instructing, and many other applications. Over the past several years, particularly since the impact of COVID-19, online streaming is the fastest growing sector of video content. This trend is all but certain to continue.

Individual users and business alike are looking for more advanced tools to allow the capturing and merging of real-time video feeds from multiple cameras. Users can quickly generate selfie videos that can be used to teach, inform, demonstrate, influence, or sell products and services and post the videos to various social media platforms. In many cases, products being promoted or demonstrated can be part of an event occurring at the same time in the same location as the maker of the selfie or at another location some distance away. The ability to combine a selfie video from one camera on a mobile device while capturing a product demonstration or event occurring at the same time and merging the two video streams in real-time gives a tremendous advantage to users trying to influence and sell products or promote events. Video processing and effects that allow a user to separate the individual in the foreground of a video from the background, smooth the separated image, resize, and place the individual's video from one camera into the video of a second camera can have many powerful applications. Producing a smoothed, separated, and edited video of a presenter in real time and merging it with a product presentation that can allow ecommerce sales as a livestream event is occurring. Adding a virtual shopping cart, coupons, and product cards makes real-time video overlaying and sharing an invaluable tool for influencers and businesses alike.

Technologies relating to real-time video overlaying and sharing from multiple mutually synchronous cameras are disclosed. The technologies described in the present disclosure may provide the following technical advantages. First, the disclosed technology utilizes only a mobile device or a wearable device to perform real-time video overlaying display from two synchronous cameras in one device which is highly favorable for live online streaming applications. In some embodiments, real-time video from a second synchronous camera can be from a second mobile or wearable device.

Second, with a synchronizing process applying on video data, depth data, and face metadata captured by the front camera, the disclosed technology may generate a binary mask of the same frame rate as live video and allow real-time video processing. This enables a subsequent overlaying process to overlay the face video with the background video.

Third, the disclosed technology provides several smoothing and transforming processes on the real-time video which makes the video fit into the background without looking like a shadow or silhouette. This also includes techniques that make the person creating the live video stream to be able to jump or move dynamically. Some techniques of the present disclosure provide drag-and-zoom functions as well. The present disclosure allows online livestream producers to interact with audiences much more easily and flexibly in any kind of outdoor video.

Finally, the disclosed technology may not only overlay or superimpose the selfie video with background video, but may also overlay the selfie video with another selfie video in another camera. This provides more possibilities and capabilities for livestreaming applications in the future.

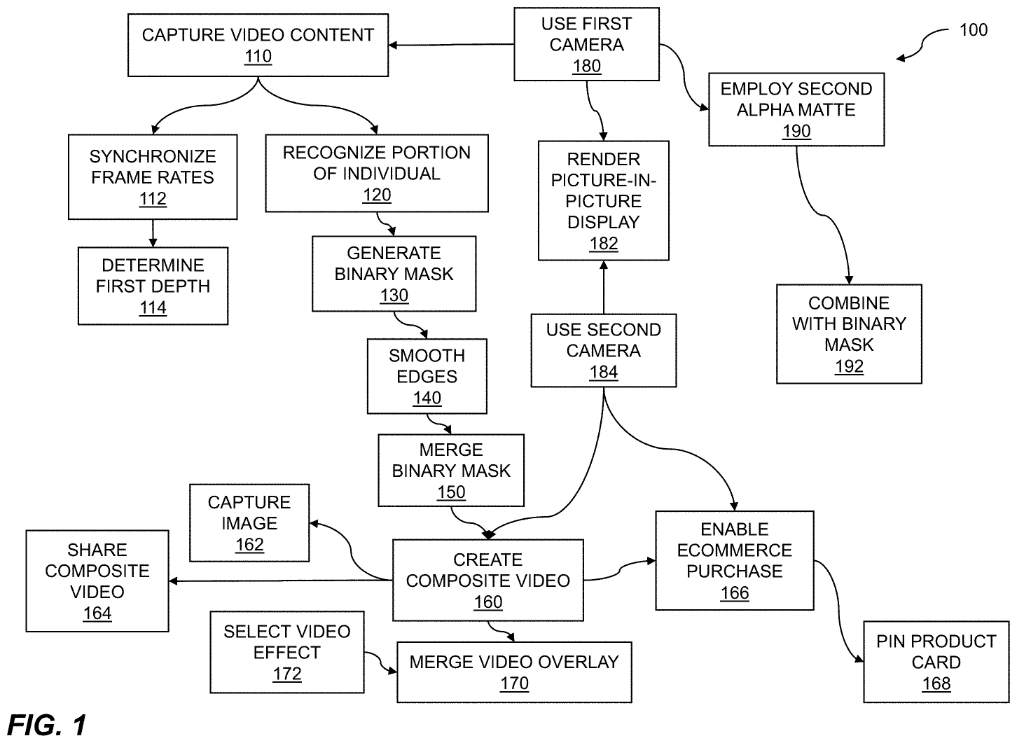

FIG. 1 is a flow diagram 100 for real-time video overlaying and sharing. An individual can record video output using a first camera on a mobile device. The video output from the first camera can be captured, and a portion of an individual can be recognized in the captured video output and used to determine a user body contour. A binary mask can be generated, wherein the binary mask enables real-time video processing which separates the user body contour from the background of the video output from the first camera. Smoothing can be applied to the binary mask. Contour smoothing controls the angularity or roundness of the contour lines. The smoothed binary mask can be merged with the video output from the first camera, producing a merged first camera video output. The merged first camera output includes the user body contour and a blank background. A composite video can be created, wherein the merged first camera video output is overlaid onto a video output from a second camera. The second camera can be included on the same mobile device that contains the first camera and can face in an opposite direction from the first camera. The second camera can be attached to a second mobile device. The composite video can be viewed on the first mobile device and shared with a second mobile device. The sharing can be accomplished using a website or mobile application. The composite video can be included in a livestream event. Ecommerce purchase options can be merged with the composite video and a product card to complete purchases in real time.

The flow 100 includes capturing video content 110 using a first camera 180. In embodiments, a first camera 180 on a first mobile device can be used to record real-time video. The video output can be captured 110 and the frame rate of the video data can be synchronized 112 with the frame rate of a depth sensor camera on the first mobile device. A depth sensor camera, also known as a Time of Flight or ToF camera, uses pulses of laser light to create a three-dimensional map of an image, such as an individual recording a video of him- or herself. The map can be generated in real time and used to apply various effects to images and videos. The rate at which the depth sensor camera produces the three-dimensional map must be synchronized to the frame rate used by the first video camera. The video content can be used to detect the presence of an individual (or a portion thereof) or the face of an individual in the video 120. Face detection can be done using artificial-intelligence-based technology to locate human faces in digital images. Once AI algorithms detect a face in a digital image, additional datasets can be used to compare facial features in order to match a face located in video image with a previously stored faceprint and complete the recognition of a particular individual. The metadata frame rate related to a face identified in the video content from the first camera must also be synchronized 112 with the video output and depth data described earlier.

The flow 100 includes determining a first depth between a user face and the first camera 114. In embodiments, data from a depth sensor camera can be used to determine the distance between the first camera 180 on the mobile device used to capture video content and the face of the individual holding the mobile device. The first depth can be combined with a predetermined cutoff depth, for example 0.25 meters, to set the maximum distance from the first camera in order to generate a binary mask 130. A binary mask is a digital image consisting of zero and non-zero values. In some embodiments, a binary mask can be used to filter out all digital pixel data that is determined to come from objects that are either closer or farther away from the first camera than the first depth or cutoff depth. For example, an individual holds a mobile device with a first camera facing toward the individual and records a video. A depth sensor camera on the mobile device determines that the distance from the camera to the individual's face as 0.75 meters. A predetermined cutoff depth of 0.25 meters can be used in combination with the first depth distance to create a binary mask of the portion of the individual recording the video. The binary mask is created by leaving unchanged all pixel values registered by objects determined by the depth sensor as being between 0.75 and 1.00 meters from the camera and setting to 0 all pixel values registered by objects that are closer to the camera than 0.75 meter or farther away from the camera than 1.00 meter.

The flow 100 includes smoothing one or more edges 140 of a binary mask 130 generated from the captured video content of a first camera. In embodiments, digital image edge smoothing uses algorithms to remove all pixels placed at the farthest corner of the edge of an object and replace them with background pixels. In combination with the binary mask 130 process, pixels on the outside edge of the binary mask can be set to 0. The result is a sharper contrast between the edge of the binary mask and the background, as well as a smoother outline on the binary mask itself. In some implementations, the step of smoothing one or more edges 140 of the binary mask 130 can include creating a first alpha matte on the binary mask and upscaling the first alpha matte to RGB resolution after creating the first alpha matte on the binary mask. Video matting is a technique for separating a video into two or more layers, for instance, foreground and background. In embodiments, the binary mask can be used to create an outline on a black video frame. All pixels within the boundaries of the binary mask are transparent, allowing only the video from the first camera to be displayed. The rest of the alpha matte is black. The result when combined with the binary mask and the video from the second camera is a smooth blending of the two video images. In some embodiments, a second alpha matte 190 can be used to combine with the binary mask 192. The second alpha matte can be used to correct the orientation of the first camera video, if necessary.

The flow 100 includes a second camera 184. In embodiments, the first camera 180 and the second camera 184 can be included on a first mobile device. In some embodiments, the first camera and the second camera are facing in opposite directions. The video output from the first camera can be merged with the binary mask 150 and combined with video output from the second camera on the display of the first mobile device. In some embodiments, the first and second cameras can be included in a wearable device. The result is a picture-in-picture display 182, wherein the merged first camera video output is overlaid on the video output from the second camera. The combined video outputs from the first and second cameras, including the binary mask generated from the first camera output, can be merged to create a composite video 160.

The flow 100 includes sharing a composite video 164 with a second mobile device. In some embodiments, the sharing can be accomplished using a website or a mobile application. Single images from the composite video can be captured 162 on a second mobile device and used in marketing, instruction, messaging, etc. The composite video can be included in a livestream event. The composite video can be used as a single, independent content object which can be manipulated as such in real time, or recorded for additional video processing at a later time. The composite video can be selected by a user on a second mobile device for a video effect overlay 172 from a library of video effect overlays. In some embodiments, the video effect overlay 172 can be merged with the created composite video 170. For example, an individual with a first camera 180 mobile device can make a video of themselves watching a sporting event. A second camera 184 on the same mobile device can record the sporting event which the individual is watching. Both cameras record video at the same time. The video content from the first camera 180 can be captured 110, the individual's face can be recognized, and face metadata can be generated. A depth sensor camera on the mobile device can determine the distance from the first camera to the individual's face, and the frame rates from the first camera video, the depth sensor camera, and the face metadata can be synchronized 112. The depth sensor data can be used to set the first depth mark 114. A cutoff depth can be set using a predetermined distance and a binary mask can be generated 130, comprised of the portion of the individual 120 recording the videos that is between the first depth mark and the cutoff depth mark. The edges of the binary mask 130 can be smoothed 140, and in some embodiments an alpha matte can be generated. The smoothing data and the alpha matte can be merged with the binary mask 150, and the binary mask can be combined with the video content of the second camera to render a picture-in-picture display 182. In some embodiments, a second alpha matte can be employed 190. This second alpha matte can be used to place a frame around the individual's face or to correct the orientation of the video output of the captured first camera video. The second alpha matte can be combined with the binary mask 192 along with the first alpha matte. The resulting merged video displays the portion of the individual from the first video camera in real time as they watch the sporting event along with the sporting event in real time as it is captured by the second video camera. The merged video from both cameras can be used to create a composite video that can be shared with a second individual using a separate mobile device 164. The shared composite video exists as a single video stream to the individual using a second mobile device that receives the composite video. The sharing can be accomplished using a website or a mobile application. The individual using the second mobile device can select video effects 172 and merge the video effect overlay with the composite video. For example, a frame could be placed around the composite video from the first individual with the name of the individual recording the sporting event and the names of the teams playing against each other.

The flow 100 includes enabling ecommerce purchases 166. In some embodiments, the composite video from the first mobile device can be included in a livestream event. The video output from a second camera can include at least one product for sale, selected from a library of products. In some embodiments, the one or more products for sale can be recognized by machine learning. A product card can be pinned 168 in the livestream window, using one or more processors, to represent the product for sale. In some embodiments, a coupon overlay can be added that viewers can use as part of the purchasing of the one or more products for sale. In some embodiments, the second camera can be used by a second individual with a separate mobile device. For example, an individual with a first mobile device can use a video camera to record real-time video. The video output from the first camera can be captured and used to create a composite video that includes the individual, separated from the background of the first camera real-time video by a binary mask 150 in the manner described above. A second individual with a second camera 184 on a separate mobile device can record real-time video that includes one or more products for sale. The video from the first camera, including the binary mask, can be combined with the video output from the second camera to create a composite video that displays content from the individual with the first mobile device with the content from the second mobile device. Thus, the first individual can be viewed along with the one or more products for sale on a single livestream event. The composite livestream video can be enabled for ecommerce purchase options 166, including a pinned product card 168 featuring the one or more products for sale included in the video content from the second camera. Various steps in the flow 100 may be changed in order, repeated, omitted, or the like without departing from the disclosed concepts. Various embodiments of the flow 100 can be included in a computer program product embodied in a non-transitory computer-readable medium that includes code executable by one or more processors.

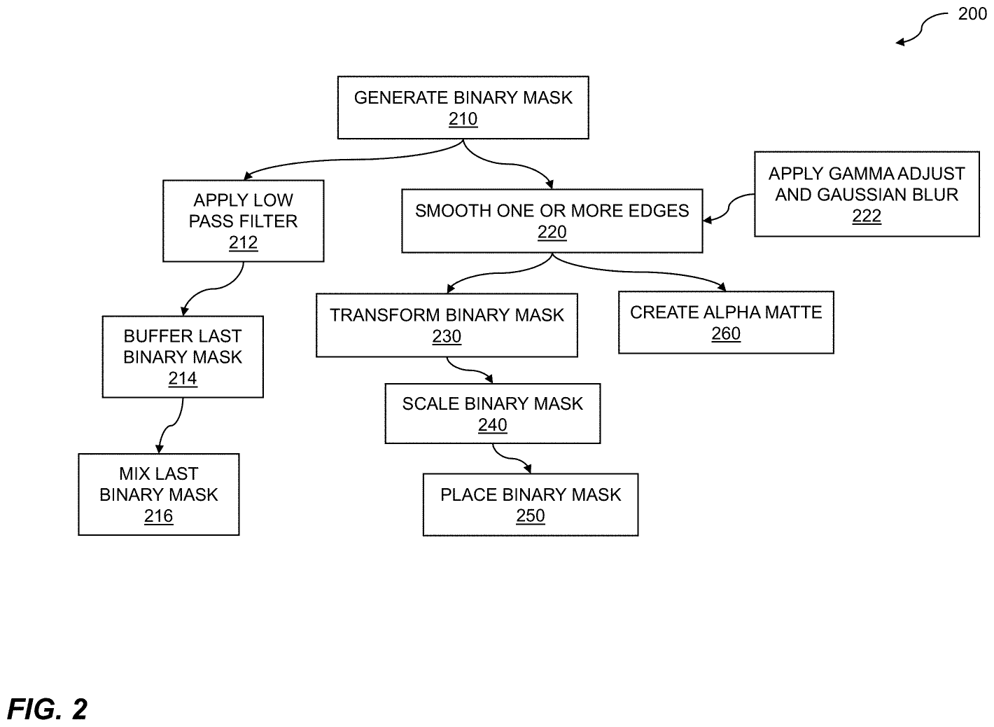

FIG. 2 is a flow diagram for binary mask manipulation. Various processes can be applied to captured video content from a camera to generate and refine a binary mask. In photography, a mask is an opaque plate with holes or transparent sections. The mask plate acts as a separate layer that can be placed on top of a developed photograph. Thus, only the portions of the photograph that are directly under the transparent portion of the mask plate can be seen. The rest of the photograph is hidden or masked from view by the opaque sections of the mask plate. In video streaming, a binary mask functions similarly. The contour of a selected image, such as the face and body of an individual in the foreground of a video, can be detected and used to generate the outline of the visible portion of the binary mask. The rest of the image in each frame of the video is masked or hidden from view. As the binary mask is generated for each frame of the video stream, the selected element in the “transparent” section of the mask remains the only portion of the video that can be seen. This allows the rest of the video frame to be filled with other video elements, such as content from a second video stream. Thus, a binary mask can be used with a real-time video stream from a first camera and combined with a second video stream from a second camera to create a composite video. Refining and improving the quality of the binary mask can reduce viewer distractions as the first camera video stream is combined with the second camera video stream and seen as a seamless composite.

The flow 200 includes generating a binary mask 210 using video output that can be captured from a first mobile device. In embodiments, a binary mask can be generated using video data from the first camera, depth data from a depth sensor camera on a first mobile device, and face metadata from a portion of an individual that is recognized in the video data from the first camera. The data from the three data sources can be synchronized to the frame rate of the video data from the first camera. As described above and throughout, the binary mask is determined using the distance between the first camera and the user face. This distance is called the first depth—the minimum distance between the first camera and the user. A depth sensor camera can be used to determine the first depth. A cutoff depth can be used to define the maximum distance between the first camera and the user. In some embodiments, a cutoff depth can be selected in advance and can be altered as required. A user body contour can be formed from objects in the video frame that are between the first depth and the cutoff depth. The user body contour can act as the boundary or outline of the binary mask, separating the user body contour from the background of the video output from the first camera.

The flow 200 includes smoothing one or more edges of the binary mask 220. In embodiments, binary mask smoothing controls the angularity or roundness of the user body contour or outline. Smoothing is done using AI operations which alter pixel values at the outer edge of the binary mask. Based on the calculations being used, some pixels that were originally included in the boundary layer of the binary mask are replaced with the values of the background layer. In some embodiments, gamma adjust and gaussian blur 222 can be applied to the binary mask. Image gamma adjustment changes the brightness levels recorded by a digital camera to values that more closely resemble the way our human eyes perceive them. When twice the number of light photons strike a digital camera sensor, it records twice the signal, thus twice the brightness. However, our eyes perceive twice the light photons seen from a particular object as being only a fraction brighter, and increasingly so for higher light intensities. Human eyes are much more sensitive to changes in dark tones as they are to similar changes in bright tones. Gamma adjustment redistributes tone levels in digital camera images, bringing them closer to the values at which our eyes perceive them. Gaussian blur is applied by using a mathematical function named after the mathematician Carl Friedrich Gauss to adjust the binary mask. The pixels that make up the video image are filtered using a kernel. This process uses a weighted average of the pixels surrounding the selected pixel such that distant pixels receive a lower weight than those at the center of the kernel. The level of blurring can be adjusted by altering the size of the kernel. The result is an image that appears smoother; the transition from one section of the image to the next is more gradual. When applied to the binary mask, the transition from the edge of the mask to the background is rendered more gradual, thus smoother.

The flow 200 includes applying a low pass filter 212 to the binary mask 210. In embodiments, a low pass filter can be used to filter out high frequency noise or unwanted signals that may be captured within a video frame. A cutoff frequency level is used to mark which lower frequency signals are retained while higher frequencies are rejected. The result is that the video image is smoothed and slightly blurred, thus more accurately resembling the object to the human eye. In some embodiments, the applying a low pass filter 212 to the binary mask 210 refines the edge of the mask so that the transition between the image from the first camera to the image from the second video camera appears more natural to the human eye.

The flow 200 includes transforming the binary mask 230. In embodiments, the smoothing one or more edges of the binary mask further comprises transforming the binary mask to allow a drag-and-zoom feature. The zoom feature allows the binary mask to be resized within the video frame as discussed below. The drag feature allows the binary mask to be placed in a different location in the video frame as discussed below.

The flow 200 includes scaling the binary mask 240. In embodiments, the transformed binary mask 230 from the first camera video can be larger or smaller than desired when combined with the contents of the second camera video. Image scaling is the process of resizing a digital image. Scaling down an image makes it smaller, while scaling up an image makes it larger. In some embodiments, scaling the binary mask 240 can allow the user to set the size of the mask so that it fits more naturally with the overall scale of the video captured from a second camera. In some embodiments, the resizing of the binary mask can be called a zoom feature.

The flow 200 includes placing the binary mask 250. In embodiments, the transformed binary mask 230 can be in a position in the video frame that blocks or distracts from portions of the video captured from the second camera. Placement allows a user to decide where to position the binary mask 230 within the frame of the composite video generated by combining the first camera binary mask video with the video from a second camera. The ability to position the binary mask 230 within the video frame can be called a drag feature. Thus, the binary mask placing 250 can be combined with binary mask scaling 240 to create a drag-and-zoom feature. As described above, changing the placement of the binary mask 250 in the composite video can allow the user to tailor the elements to be either emphasized or understated. For example, the user can choose to center the individual appearing within the binary mask of the first camera video and scale them larger to emphasize the individual and their speech and gestures while the second camera video plays in the background. The user can choose to scale the binary mask smaller and position it to one side of the composite video frame in order to draw attention to the contents of the second camera video while being commented by the individual captured by the first camera video. The combination of “scale binary mask” 240 and “place binary mask” 250 can give the user options to control and compose the elements of the composite video to achieve the drag-and-zoom effect emphases desired.

In the flow 200, after applying gamma adjust and gaussian blur 222 and one or more low pass filter 212 to the binary mask, the result must be stored in a memory buffer 214. The results of each of the video processes can be mixed in order to generate the last binary mask 216. The mixing of the original binary mask 210 with gamma adjust and gaussian blur smoothing and low pass filter 212 occurs dynamically as the first camera video is captured and stored in memory buffer 214. In some embodiments, the binary mask is used to create an alpha matte 260. An alpha matte is a video clip, or image, which is used to create a transparency layer for another video clip. When used in combination with the binary mask 210 and the first camera video, the only visible portion of the first camera video is that which is within the binary mask 230 and alpha matte 260—the visible face and body of the individual contained in the foreground of the first camera video. In some embodiments, the alpha matte can be upscaled to RGB resolution. Various steps in the flow 200 may be changed in order, repeated, omitted, or the like without departing from the disclosed concepts. Various embodiments of the flow 200 can be included in a computer program product embodied in a non-transitory computer-readable medium that includes code executable by one or more processors.

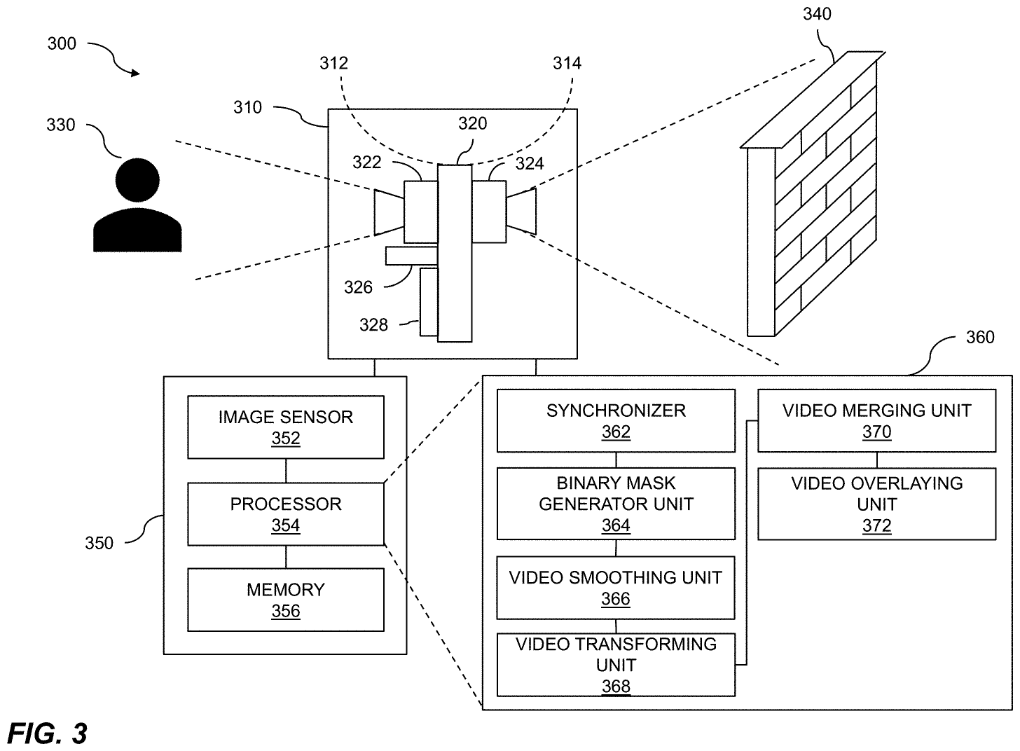

FIG. 3 is an infographic diagram illustrating an example real-time video overlaying system 300. The real-time video overlaying system 300 includes a user device 310 and an image processing unit 350. The user device 310 includes a device body 320 having a first side 312 and a second side 314; a first camera 322 formed on the first side 312 of the device body 320; a second camera 324 formed on the second side 314 of the device body 320; a depth sensor 326 formed on the first side 312 of the device body 320; and a display 328 formed on the first side 312 of the device body 320.

An exemplary method of real-time video overlaying includes the steps of: synchronizing frame rates of a depth data, a face metadata, and a video data of a first camera video output captured by a first camera; determining a first depth between a user face and the first camera; using a cutoff depth to determine a user body contour; generating a binary mask of the user body contour based on the first depth and the cutoff depth; smoothing an edge of the binary mask; merging the binary mask with the first camera video output and generating a merged first camera video output; and overlaying the merged first camera video output onto a second camera video output.

In some implementations, the first depth is determined by a depth sensor. Embodiments may include the step of synchronizing frame rates. Further embodiments may also include the use of a binary mask, wherein any point on the binary mask further than the user body contour is set to a value of 0, and any image point that falls within the user body contour is set to a value of 1.

The method of real-time video overlaying, in some implementations, further includes: applying a low pass filter on the binary mask after generating the binary mask of the user body contour. In some implementations, the step of applying the low pass filter on the binary mask after generating the binary mask of the user body contour further includes: temporarily buffering a last binary mask that corresponds to a last frame, and then mixing the last binary mask with a current binary mask that corresponds to a current frame, and then generating the binary mask according to a combination of the last frame and the current frame. The combination of the last frame and the current frame follows an exemplary equation: the binary mask=last frame*0.4+current frame*0.6. The step of smoothing an edge of the binary mask further includes: creating a first alpha matte on the binary mask and upscaling the first alpha matte to RGB resolution after creating the first alpha matte on the binary mask.

The method of real-time video overlaying, in some implementations, further includes a step of: smoothing the binary mask by applying a gamma adjust process and a gaussian blur process; and transforming the binary mask to allow a drag-and-zoom feature. Applying the gamma adjust process further includes applying a CIGammaAdjust filter. In some implementations, the step of applying the gaussian blur process further includes applying a CIGaussianBlur filter.

In embodiments, the step of transforming the binary mask further includes: scaling the binary mask to the same size as the second camera video output, and placing the binary mask at a position corresponding to a bottom center of the second camera video output after scaling the binary mask to the same size as the second camera video output. The step of merging the binary mask with the first camera video output and generating the merged first camera video output further includes: applying a second alpha matte to the first camera video output; correcting an orientation of the first camera video output; and applying a CIBlendWithMask filter to merge the first camera video output with the binary mask.

The user device 310 includes an electronic device such as a mobile phone or a wearable device.

The device includes a first camera 322, which is a front camera of a mobile phone, and a second camera 324, which is a back camera of the mobile phone. Therefore, the two cameras are formed at opposite sides of the user device 310 and thus have opposite camera views. This allows the user device 310 to capture a first video of a first user face 330 and a second video of a background view 340 synchronously with contradictory visions. The first camera 322 may also include a depth sensor embedded in it.

The image processing unit 350 includes an image sensor 352, an image processor 354, and a memory 356. In some implementations, the image processing unit 350 may be implemented in or part of the user device 310. For example, it the image processing unit can be embedded in the device body 320. In some implementations, a part of the image processing unit 350 may be remotely located outside of the user device (i.e., the image processor 352 may be located beyond the user device), because it can be a cloud-based computation, and therefore, it is not arranged on the user device 310.

In some implementations, the image sensor 352 is configured to convert light waves captured via cameras into signals such as analog signals, digital signals, or optical signals. The image sensor 352 may include a charge-coupled device (CCD) and the active-pixel sensor (CMOS sensor).

In some implementations, the image processor 352 is configured to provide several image processing units 360 including (1) a synchronizer unit 362 configured to synchronize a first video data captured by the first camera 322, face metadata captured by the first camera 322, and depth data captured by the depth sensor 326; (2) a binary mask generator unit 364 configured to generate a binary mask from the first video data captured by the first camera 322 to be processed and modified; (3) a video smoothing unit 366 configured to smooth an edge of the binary mask; (4) a video transforming unit 368 configured to transform the binary mask to allow a drag-and-zoom feature; (5) a video merging unit 370 configured to merge the binary mask with the first video data, and generate a merged first video data; and (6) a video overlaying unit 372 configured to overlay the merged first video data onto the second video data captured by the second camera. The image processing units and their functions of the above image processor 354 may be implemented by using image processing methods and corresponding codes or algorithms in accordance with some implementations of the present disclosure. These image processing methods, corresponding codes, and algorithms will be discussed in detail in a subsequent section.

In some implementations, the memory 356 includes a hard drive or a flash memory. The memory 356 is configured to provide temporary or permanent data storage including storage of depth data, image data, or video data before, during, or after the real-time video overlaying process.

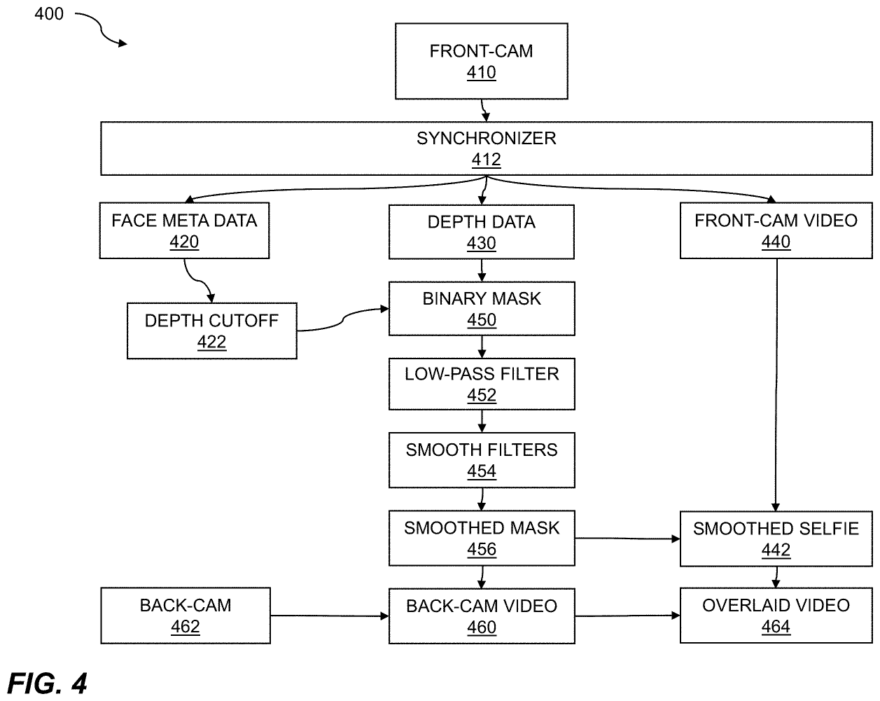

FIG. 4 is a flowchart illustrating a method 400 of real-time video overlaying and superimposing display from multiple mutually synchronous cameras in accordance with some implementations of the present disclosure. As shown in FIG. 4, the method 400 includes capturing a first video via a front camera 410; and synchronizing 412 face metadata 420, depth data 430, and the first video of the front camera 440 into the same frame rate, e.g., at 60 frames-per-second (FPS). As mentioned above, the front camera, the back camera, and the depth sensor may be clocked differently. For example, the front camera and the depth sensor may have different frame rates. For them to work together, a synchronizing process is required to synchronize the frame rate.

In some implementations, an AVCaptureDataOutputSynchronizer from Apple may be used to achieve the synchronizing process. The AVCaptureDataOutputSynchronizer is an object that coordinates time-matched delivery of data from multiple capture outputs.

Next, after the synchronizing process, a real-time segmentation process is performed. Segmentation separates elements within the video frame into two groups: foreground and background. Conventionally, a segmentation process may be done by processing the front camera output frame by frame by using the DeepLabV3 model or TrueDepth 3D sensor. For DeepLabV3, an Atrous Convolution is applied over the input feature map where the atrous rate corresponds to the stride with which the input signal is sampled. This is equivalent to convolving the input with upsampled filters produced by inserting zeros between two consecutive filter values along each spatial dimension. By adjusting the atrous rate, we can adaptively modify the filter's field of view. This is also called dilated convolution (DilatedNet) or Hole Algorithm, as the term “atrous” relates to holes. Atrous convolution allows enlarging of the field of view of filters to incorporate large context. It thus offers an efficient mechanism to control the field of view and finds the best tradeoff between accurate localization (small field-of-view) and context assimilation (large field-of-view). In some examples, atrous convolution applies a mechanism known as Atrous Spatial Pyramid Pooling (ASPP). However, these two approaches may not deliver results in real time.

As shown in FIG. 4, the method 400 further includes checking whether there is a face in the face metadata feed 420. If so, determining a center point of the face, and collecting a depth data 430 between the center point of the face and the front camera can be accomplished. A cutoff depth can be determined in advance to allow the whole body to appear in the video and to account for distance measuring errors. In some implementations, the cutoff depth is 0.25 meters.

In some implementations, the method 400 further includes setting a maximum depth, so that the user can do something fun like “jumping” into the video from nowhere. Therefore, in some implementations, the maximum depth may be set to 1.2 meters to allow for the “jump-in” effect of the video.

The exemplary codes to execute the steps above of the method 400 may be as follows:

```
  if let firstFace = syncedMetaData?.metadataObjects.first,
  let connection = sessionManager.frontCameraVideoDataOutput.connection(with:
AVMediaType.video),
  let face = sessionManager.frontCameraVideoDataOutput.transformedMetadataObject(for:
firstFace, connection: connection) {
  let faceCenter = CGPoint(x: face.bounds.midX, y: face.bounds.midY)
  let scaleFactor = CGFloat(CVPixelBufferGetWidth(depthPixelBuffer)) /
CGFloat(CVPixelBufferGetWidth(videoPixelBuffer))
  let pixelX = Int((faceCenter.x * scaleFactor).rounded( ))
  let pixelY = Int((faceCenter.y * scaleFactor).rounded( ))
  if pixelX < depthHeight && pixelX >= 0 && pixelY < depthWidth && pixelY >= 0 {
    CVPixelBufferLockBaseAddress(depthPixelBuffer, .readOnly)
    let row Data = CVPixelBufferGetBaseAddress(depthPixelBuffer)! + pixelX *
CVPixelBufferGetBytesPerRow(depthPixelBuffer)
    let faceCenterDepth = rowData.assumingMemoryBound(to: Float32.self)[pixelY]
    CVPixelBufferUnlockBaseAddress(depthPixelBuffer, .readOnly)
    // 1.2 is a number to allow for “jump-in” effect
    sessionManager.depthCutOff = min(faceCenterDepth + 0.25, 1.2)
  }
  }
```

Next, in order to perform real-time video processing, the method 400 further includes generating a binary mask 450 of the user's body contour by using the cutoff depth from the previous step. Any point further than the user's body contour will be set to a value of 0 and will eventually be filtered off. Also, with the aid of the binary mask, any image point that falls within the user's body contour will be assigned a non-zero value, e.g., 1, such that the image point will be kept. By assigning binary values to image points, the method 400 may effectively process image points without introducing a heavy cost. This enables the system to do the calculation in real time at, for example, 60 FPS.

Although real-time video processing is often desired, it should be noted that the depth data feed has a very low resolution. Therefore, the resulting image is very sensitive to lighting conditions, especially on the edges of the body contour. Moreover, such a phenomenon will render a constantly changing binary mask which may sabotage the final result.

To deal with such a phenomenon, the method 400 further includes applying a low pass filter (LPF) 452 on the binary mask 450. More specifically, the method 400 further includes temporarily buffering a last binary mask that corresponds to a last frame (lastData), and then mixing the last binary mask with a current binary mask that corresponds to a current frame (currentData). In this way, a final result is generated according to the following exemplary equation:

filteredResult=lastData*0.4+currentData*0.6

With the aid of the LPF, this generates a good final result at a low computational cost.

One of the exemplary codes to achieve the above goal may be as follows:

```
CVPixelBufferLockBaseAddress(depthPixelBuffer, CVPixelBufferLockFlags(rawValue: 0))
  if let lastDepthDataPixelBuffer = lastDepthDataPixelBuffer {
  CVPixelBufferLockBaseAddress(lastDepthDataPixelBuffer,
CVPixelBufferLockFlags(rawValue: 0))
  if CVPixelBufferGetWidth(lastDepthDataPixelBuffer) != depthWidth ||
CVPixelBufferGetHeight(lastDepthDataPixelBuffer) != depthHeight {
    self.lastDepthDataPixelBuffer = nil
  }
  }
  for yMap in 0 ..< depthHeight {
  let rowData = CVPixelBufferGetBaseAddress(depthPixelBuffer)! + yMap *
CVPixelBufferGetBytesPerRow(depthPixelBuffer)
  let lastRowData : UnsafeMutableRawPointer? = (lastDepthDataPixelBuffer != nil) ?
    CVPixelBufferGetBaseAddress(lastDepthDataPixelBuffer!)! + yMap *
CVPixelBufferGetBytesPerRow(lastDepthDataPixelBuffer!)
    : nil
  let data = UnsafeMutableBufferPointer<Float32>(start:
rowData.assumingMemoryBound(to: Float32.self), count: depthWidth)
  let lastData : UnsafeMutableBufferPointer<Float32>? = (lastRowData != nil) ?
    UnsafeMutableBufferPointer<Float32>(start: lastRowData!.assumingMemoryBound(to:
Float32.self), count: depthWidth)
    : nil
  for index in 0 ..< depthWidth {
    if data[index] > 0 && data[index] <= sessionManager.depthCutOff {
    data[index] = 1.0
    } else {
    data[index] = 0.0
    }
    if let lastData = lastData {
    let lowPassFilterFactor:CGFloat = 0.4
    let current = data[index] * Float32(1.0-lowPassFilterFactor)
    let last = lastData[index] * Float32(lowPassFilterFactor)
    data[index] = current + last
    }
  }
  }
  if let lastDepthDataPixelBuffer = lastDepthDataPixelBuffer {
  CVPixelBufferUnlockBaseAddress(lastDepthDataPixelBuffer,
CVPixelBufferLockFlags(rawValue: 0))
  }
  CVPixelBufferUnlockBaseAddress(depthPixelBuffer, CVPixelBufferLockFlags(rawValue: 0))
  lastDepthDataPixelBuffer = depthPixelBuffer.copy( )
```

Because the binary mask 450 may still introduce pixelated edges and, given an outdoor environment with strong lighting, the user's body contour may be partially cut off due to the roughness of the depth sensing, the method 400 further includes a smoothing process to generate a smoothed mask 454. First, the method 400 includes smoothing an edge of the binary mask by creating a first alpha matte on the binary mask. Second, the method 400 includes smoothing the binary mask by applying a gamma adjust process and a gaussian blur process. Third, the method 400 further includes transforming the binary mask to allow a drag-and-zoom feature. It is noted that alpha matte is opaque when a pixel value of the alpha channel is 100%, where the alpha channel is used for communicating transparency information.

In some implementations, the step of applying the gamma adjust process includes applying a CIGammaAdjust filter. Further embodiments may include the step of applying the gaussian blur process by use of a CIGaussianBlur filter.

One of the exemplary codes to achieve the above steps may be as follows:

```
// Create the mask from that pixel buffer.
  let depthOrientation =
Util.imageOrientationToFixCaptureVideoOrientation(videoOrientation:
sessionManager.depthDataOutputConnection!.videoOrientation)
  let depthMaskImage = CIImage(cvPixelBuffer: depthPixelBuffer,
  options:
[:]).oriented(depthOrientation)
  let (blurRadius, gamma) = Util.superimposeConfig(brightness:
  lastBrightness)
  // Smooth edges to create an alpha matte, then upscale it to the
  RGB resolution.
  if frontVideoWidth == nil {
    frontVideoWidth = CVPixelBufferGetWidth(videoPixelBuffer)
  }
  if frontVideoHeight == nil {
    frontVideoHeight = CVPixelBufferGetHeight(videoPixelBuffer)
  }
  // Used max to be orientation-safe
  let alphaUpscaleFactor = Float(max(frontVideoHeight!,
  frontVideoWidth!)) /
Float(max(depthWidth, depthHeight))
  if frontImageTransform == nil {
    let backVideoWidth = backCamImage.extent.size.width
    let backVideoHeight = backCamImage.extent.size.height
    // Place front cam video at the bottom center
    let scale = backVideoWidth / CGFloat(frontVideoWidth!)
    frontImageTransform = CGAffineTransform(scaleX: scale, y: scale)
    .translatedBy(
      x: 0.0 / scale * backVideoWidth,
      y: 0.25 / scale * backVideoHeight)
    lastFrontImageTransform = frontImageTransform!
  }
  var blurredMask = depthMaskImage.clampedToExtent( )
    .applyingFilter(“CIGaussianBlur”, parameters: [“inputRadius”:
    blurRadius])
    .applyingFilter(“CIGammaAdjust”, parameters: [“inputPower”:
    gamma])
    .cropped(to: depthMaskImage.extent)
```

In order for the filter combination to work well in different lighting conditions, a brightness data from Exchangeable image file format (EXIF) data of each frame is extracted, using the brightness data to derive different filter parameter combinations. It is noted that EXIF is a standard that specifies the formats for images, sound, and ancillary tags used by digital cameras (including smartphones), scanners and other systems handling image and sound files recorded by digital cameras.

One of the exemplary codes to achieve the above step may be as follows:

```
public static func getBrightness(sampleBuffer:CMSampleBuffer) −> Double {
  //Retrieving EXIF data of camera frame buffer
  let rawMetadata = CMCopyDictionaryOfAttachments(allocator: nil, target: sampleBuffer,
attachmentMode: CMAttachmentMode(kCMAttachmentMode_ShouldPropagate))
  let metadata = CFDictionaryCreateMutableCopy(nil, 0, rawMetadata) as
NSMutableDictionary
  let exifData = metadata.value(forKey: “{Exif}”) as? NSMutableDictionary
  let brightness = exifData?.object(forKey: kCGImagePropertyExifBrightnessValue) as?
Double
  return brightness ?? 0.0
  }
  // (blurRadius, gamma)
  public static func superimposeConfig(brightness:Double) −> (Float, Float) {
  if brightness >= 7.8 {
    return (10.0, 0.12)
  } else if brightness > 5.0 {
    return (5.0, 0.2)
  } else {
    return (1.0, 1.0)
  }
  }
```

Next, the method 400 includes merging the smoothed binary mask 456 with a first camera video output 440 which may be a selfie video output. A smoothed selfie video output 442 may be generated thereafter. That is, in some implementations, the method 400 includes applying a second alpha matte to the selfie video output, correcting an orientation of the selfie video output, and applying CIBlendWithMask Filter to blend the selfie video output with the smoothed binary mask. A smoothed selfie video 442 is generated thereafter.

One of the exemplary codes to achieve the above steps may be as follows:

```
let alphaMatte = blurredMask
    .applyingFilter(“CIBicubicScaleTransform”, parameters: [“inputScale”:
alphaUpscaleFactor])
    .transformed(by: frontImageTransform!)
  let frontCamImageOrientation =
Util.imageOrientationToFixCaptureVideoOrientation(videoOrientation:
sessionManager.frontCameraVideoDataOutputConnection!.videoOrientation)
  var frontCamImage = CIImage(cvPixelBuffer:
videoPixelBuffer).oriented(frontCamImageOrientation)
  frontCamImage = frontCamImage.transformed(by: frontImageTransform!)
  // Apply alpha matte to the video.
  let parameters = [
    “inputMaskImage”: alphaMatte,
    “inputBackgroundImage”: backCamImage
  ]
  let mergedImage = frontCamImage.applyingFilter(“CIBlendWithMask”, parameters:
parameters)
```

Finally, the method includes overlaying the smoothed selfie video 442 onto the back camera video 460 captured by the back camera 462. An overlaid video 464 is generated as a result.

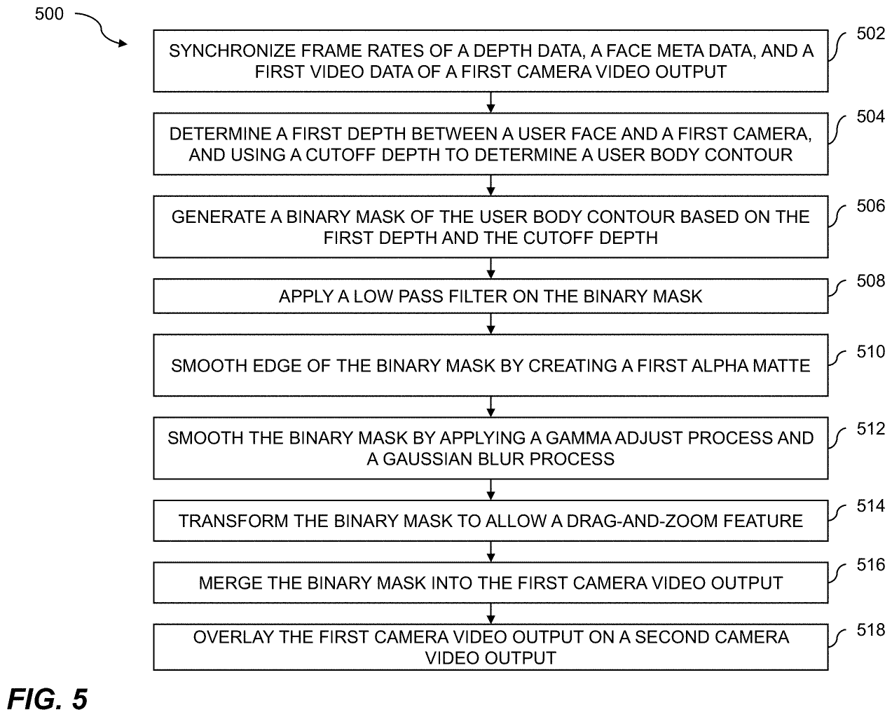

FIG. 5 is a flowchart illustrating a method 500 in accordance with some implementations of the present disclosure. The method 500 includes synchronizing frame rates of depth data, face metadata, and video data of a first camera video output captured by a first camera 502; determining a first depth between a user face and the first camera via a depth sensor, and using a cutoff depth to determine a user body contour step 504; generating a binary mask of the user body contour based on the first depth and the cutoff depth 506; applying a low pass filter on the binary mask 508; smoothing an edge of the binary mask by creating a first alpha matte onto the edge of the binary mask 510; smoothing the binary mask by applying a gamma adjust process and a gaussian blur process 512; transforming the binary mask to allow a drag-and-zoom feature 514; merging the binary mask with the first camera video output and generating a merged first camera video output 516; and overlaying the merged first camera video output onto a second camera video output captured by a second camera 518. In some implementations, the method 500 may be specified by adding more detailed steps of the method 400.

In some implementations, the first camera and the second camera are facing in the opposite direction. The step of transforming the binary mask may include scaling the binary mask to the same size (height and width) as the second camera video output. The step of transforming the binary mask may further include placing the binary mask at a position corresponding to a bottom center of the second camera video output. Finally, the step of smoothing an edge of the binary mask by creating a first alpha matte onto the edge of the binary mask further includes upscaling the first alpha matte to RGB resolution.

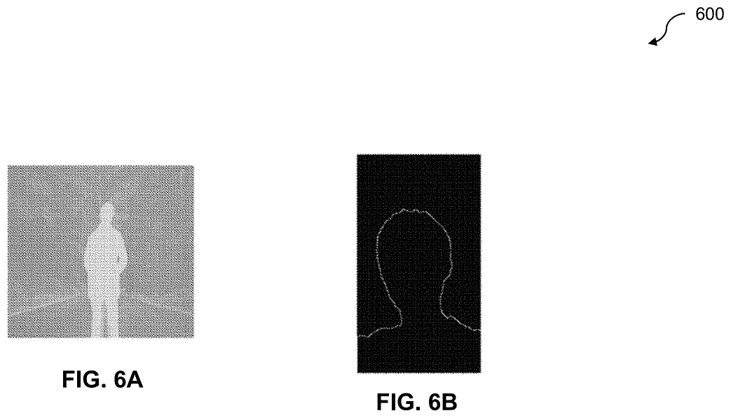

FIG. 6A is an image illustrating the exemplary extracted image using the DeepLabV3 model. The DeepLabV3 model can be used to apply real-time segmentation after the synchronizing of face metadata, depth data, and first camera video data. Segmentation divides the pixels in the video frame into two groups: foreground and background. As discussed above and throughout for DeepLabV3, an Atrous Convolution is applied over the input feature map where the atrous rate corresponds to the stride with which we sample the input signal. This is equivalent to convolving the input with upsampled filters produced by inserting zeros between two consecutive filter values along each spatial dimension. By adjusting the atrous rate, we can adaptively modify the filter's field of view. This is also called dilated convolution (DilatedNet) or Hole Algorithm. Atrous convolution allows enlarging of the field of view of filters to incorporate large context. It thus offers an efficient mechanism to control the field-of-view and finds the best trade-off between accurate localization (small field-of-view) and context assimilation (large field-of-view). In some examples, Atrous convolution applies a mechanism named Atrous Spatial Pyramid Pooling (ASPP). However, these two approaches may not deliver results in real-time.

FIG. 6B is an image illustrating the exemplary extracted image using the TrueDepth 3D sensor. The TrueDepth 3D sensor uses an infrared emitter as part of a first video camera. The infrared emitter projects over 30,000 dots in a known pattern onto the user's face. The dots are then photographed by a dedicated infrared camera for analysis. In embodiments, the results can be used to determine whether or not a face appears in the first camera video frame. In some embodiments, the TrueDepth 3D sensor can be used to capture depth data to be used as part of generating the binary mask. The depth data can be used to separate the face and body data in the first camera video from background elements that appear in the video frame. This can be part of the segmentation step that can be done after synchronization of the face metadata, depth data, and first camera video data.

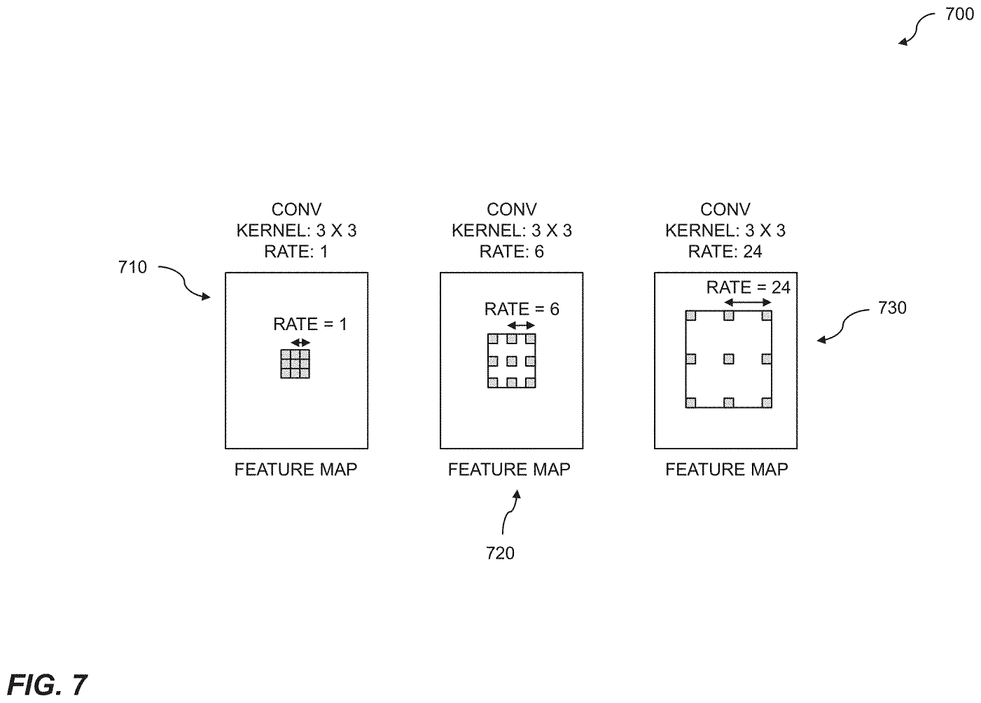

FIG. 7 illustrates the exemplary figure map for Atrous Convolution with different rates r in accordance with DeepLabV3 implementations 7000. A convolution is a mathematical operation that blends one function with another function known as a kernel to produce an output that is more interpretable. Atrous convolution uses a dilation rate to define the spacing between the values in a kernel. In some embodiments, atrous convolution can be used to make the outlines of the binary mask more distinct. In FIG. 7, the rate or stride refers to the amount of movement a filter process uses as it passes over an image. A rate of 1, as shown in the left portion 710 of the figure, sets the filter to move one pixel, or unit, at a time. A rate of 6, as shown in the middle 720 of the figure, sets the filter to move over six pixels at a time, and so on. A rate of 24, as shown in the right portion 730 of the figure, sets the filter to move 24 pixels at a time. The kernel in each of the three sections of the figure is the same 3 pixels by 3 pixels. The higher the rate used, the fewer the number of pixels may be viewed across the entire image. This process can be used to detect vertical and horizontal lines, corners, curves, and other simple features in an image. Using various patterns for the kernel function, the outline of the binary mask can be sharpened and made more distinct.

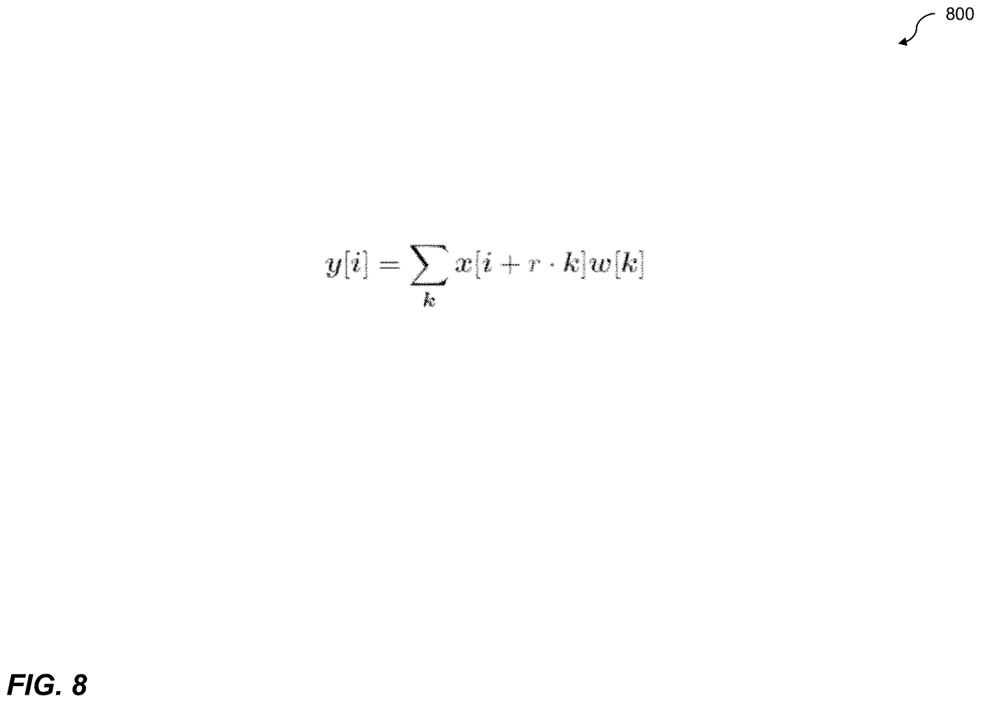

FIG. 8 illustrates the exemplary equation 800 of DeepLabV3 in accordance with DeepLabV3 implementations. For DeepLabV3, each location I on the output y and a filter w, the Atrous Convolution is applied over the input feature map x where the atrous rate r corresponds to the stride with which we sample the input signal. This is equivalent to convolving the input x with upsampled filters produced by inserting (r−1) zeros between two consecutive filter values along each spatial dimension. When r=1, it is standard convolution. By adjusting r, we can adaptively modify the filter's field of view. This algorithm may also be called the dilated convolution (DilatedNet) or Hole Algorithm.

When r=2, the input signal is sampled alternatively. First, pad-2 means 2 zeros are padded at both the left and right sides. Then, with r=2, the input signal every 2 inputs is sampled for convolution. Atrous convolution allows an enlargement of the field of view of filters to incorporate a larger context. It thus offers an efficient mechanism to control the field of view and finds the best trade-off between accurate localization (small field of view) and context assimilation (large field of view). In some examples, Atrous convolution applies a mechanism known as Atrous Spatial Pyramid Pooling (ASPP). However, these two approaches may not deliver results in real time.

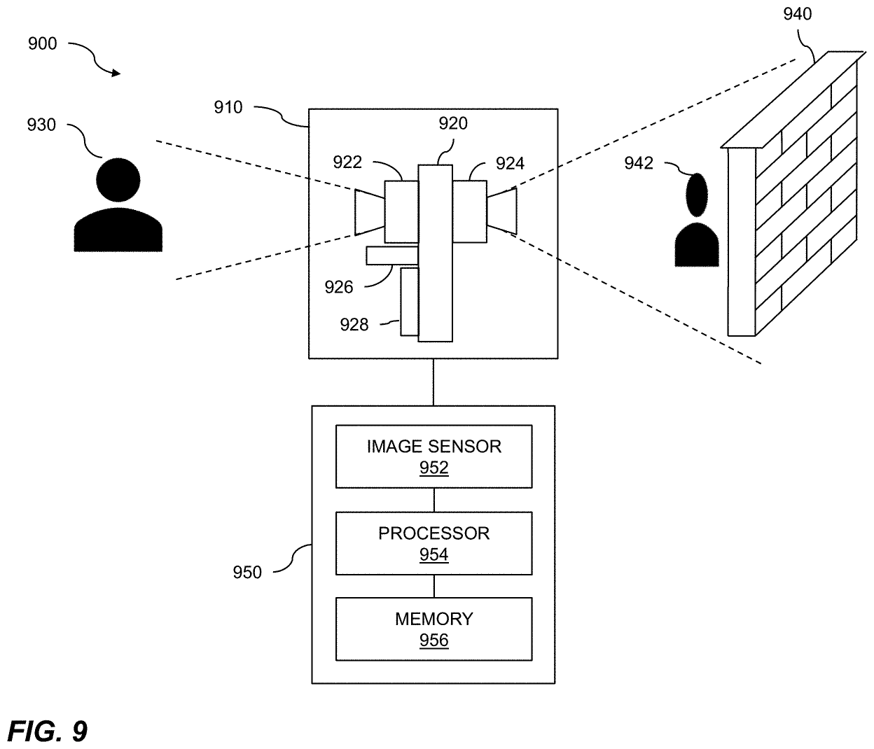

FIG. 9 is a schematic diagram illustrating an exemplary real-time video overlaying system 900 in accordance with some implementations of the present disclosure. The real-time video overlaying system 900 includes a user device 910 and an image processing unit 950. The user device 910 includes a device body 920 having a first camera 922 formed on the first side of the device body 920; a second camera 924 formed on the second side of the device body 920; a depth sensor 926 formed on the first side of the device body 920; and a display 928 formed on the first side of the device body 920. FIG. 9 is similar to FIG. 3 above. However, the real-time video overlaying system 300 is configured to overlay a selfie video of a front camera to a background video of a back camera, while the real-time video overlaying system 900 is configured to overlay a first selfie video 930 of a front camera 922 to a second selfie video of a back camera 924. Since based on the method 400 and 500, coordinates of the front user face contour and the back user face contour may be detected and determined by the front and back camera accordingly, by overlaying and superimposing the front user face contour to the back user face contour according to the coordinates, the back user face may be replaced by the front user face. Furthermore, with the aid of the real-time coordinated and boundaries of the back user face contour, the front user face contour may be dynamically resized and placed over the back user face contour.

An exemplary method of real-time video overlaying includes the steps of: synchronizing frame rates of a depth data, a face metadata, and a video data of a first camera video output captured by a first camera; determining a first depth between a user face and the first camera; using a cutoff depth to determine a user body contour; generating a binary mask of the user body contour based on the first depth and the cutoff depth; smoothing an edge of the binary mask; merging the binary mask with the first camera video output and generating a merged first camera video output. After the first and second camera video outputs have been processed, the merged first camera video output can be overlayed onto the second camera video output.

The user device 910 includes an electronic device such as a mobile phone or a wearable device. The device includes a first camera 922, which is a front camera of a mobile phone, and a second camera 924, which is a back camera of the mobile phone. Therefore, the two cameras are formed at opposite sides of the user device 910 and thus have opposite camera views. This allows the user device 910 to capture a first video of a first user face 930 and a second video of a background view 940 synchronously with contradictory visions. The first camera 922 may also include a depth sensor embedded in it.

The image processing unit 950 includes an image sensor 952, an image processor 954, and a memory 956. In some implementations, the image processing unit 950 may be implemented in or part of the user device 910. For example, the image processing unit can be embedded in the device body 920. In some implementations, a part of the image processing unit 950 may be remotely located outside of the user device (i.e., the image processor 952 may be located beyond the user device), because it can be a cloud-based computation, and therefore, it is not arranged on the user device 910.

In some implementations, the image sensor 952 is configured to convert light waves captured via cameras into signals such as analog signals, digital signals, or optical signals. The image sensor 952 may include a charge-coupled device (CCD) and the active-pixel sensor (CMOS sensor).

In some implementations, the image processor 952 is configured to provide several image processing units including (1) a synchronizer unit configured to synchronize a first video data captured by the first camera 922, face metadata captured by the first camera 922, and depth data captured by the depth sensor 926; (2) a binary mask generator unit configured to generate a binary mask from the first video data captured by the first camera 922 to be processed and modified; (3) a video smoothing unit configured to smooth an edge of the binary mask; (4) a video transforming unit configured to transform the binary mask to allow a drag-and-zoom feature; (5) a video merging unit configured to merge the binary mask with the first video data, and generate a merged first video data; and (6) a video overlaying unit configured to overlay the merged first video data onto the second video data captured by the second camera. The image processing units and their functions of the above image processor 954 may be implemented by using image processing methods and corresponding codes or algorithms in accordance with some implementations of the present disclosure. These image processing methods, corresponding codes, and algorithms are discussed in detail in the FIG. 4 section above.

In some implementations, the memory 956 includes a hard drive or a flash memory. The memory 956 is configured to provide temporary or permanent data storage including storage of depth data, image data, or video data before, during, or after the real-time video overlaying process.

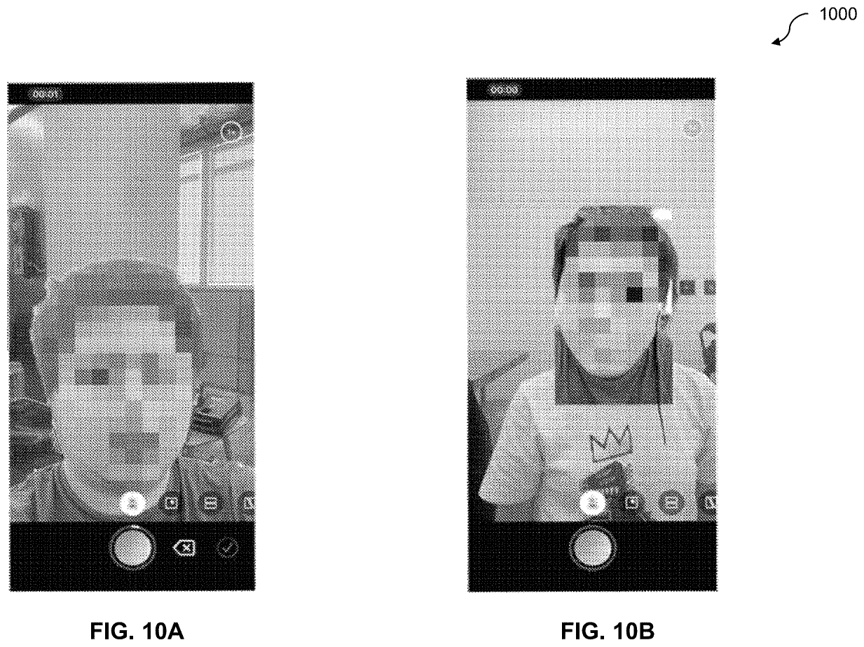

FIG. 10A is an exemplary image illustrating a result of the real-time video overlaying system 300 and the method 400, 500 in accordance with some implementations of the present disclosure. A first camera video has been captured; face metadata, and depth data have been combined and synchronized with the first camera video; a binary mask has been generated using a first depth between the user face and the first camera and a cutoff depth to determine a user body contour; a low pass filter has been applied to the binary mask; the edge of the binary mask has been smoothed by creating a first alpha matte; the binary mask has been further smoothed by applying a gamma adjust process and a gaussian blur process; the binary mask has been transformed to allow a drag-and-zoom feature; the binary mask has been merged with the first camera video output; and the merged output has been overlaid on top of a second camera video output. A frame from the composite video output can be seen in FIG. 10A.

FIG. 10B is an exemplary image illustrating a result of the real-time video overlaying system 900 in accordance with some implementations of the present disclosure. A first camera selfie video has been captured; face metadata, and depth data have been combined and synchronized with the first camera video; a binary mask has been generated using a first depth between the user face and the first camera and a cutoff depth to determine a user body contour; a low pass filter has been applied to the binary mask; the edge of the binary mask has been smoothed by creating a first alpha matte; the binary mask has been further smoothed by applying a gamma adjust process and a gaussian blur process; the binary mask has been transformed to allow a drag-and-zoom feature; and the binary mask has been merged with the first camera video output. The second camera video is a selfie video made by a different individual using a camera facing in the opposite direction on the same mobile device or a different mobile device. Coordinates of the front user face contour and the back user face contour can be detected and determined by the front and back camera accordingly, by overlaying and superimposing the front user face contour to the back user face contour according to the coordinates. Thus, the back user face may be replaced by the front user face. Furthermore, with the aid of the real-time coordinated and boundaries of the back user face contour, the front user face contour may be dynamically resized and placed over the back user face contour. A frame from the resulting composite video output can be seen.

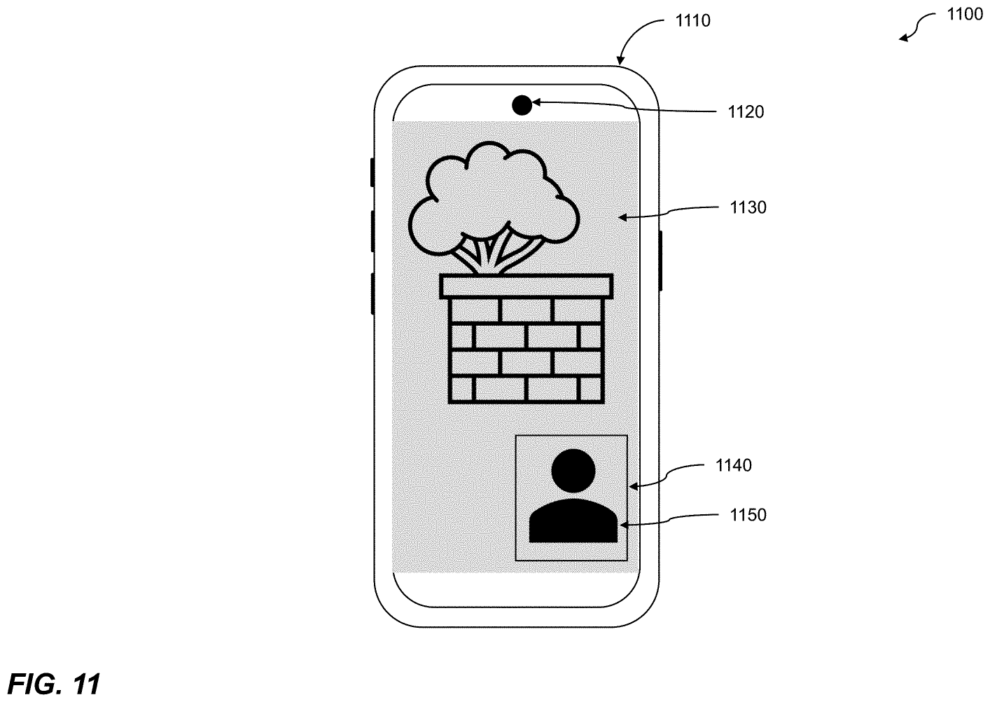

FIG. 11 is a picture-in-picture display example 1100 with real-time video overlaying and sharing. As discussed above and throughout, video output can be captured from a first camera 1120 on a first mobile device 1110. A portion of an individual can be detected and recognized in the video output that was captured, and a user body contour of the individual can be determined. A binary mask 1150 can be generated, enabling real-time video processing, which includes separating the user body contour from a background of the video output from the first camera. The user body contour can be separated from the background using a depth sensor on the first mobile device to determine a first distance from the first camera to the face of the individual using the first mobile device. A cutoff depth can be used to determine the maximum distance from the first camera to be used in generating a binary mask 1150. One or more edges of the binary mask 1150 can be smoothed using a low pass filter, a first alpha matte, a gamma adjust process, and a gaussian blur process. The binary mask 1150 can be transformed to allow a drag-and-zoom feature. The drag-and-zoom feature can allow the binary mask 1150 to be moved to a different location in the video frame. The zoom feature can allow the binary mask 1150 to be resized in the video frame. The binary mask 1150 can be merged into the first camera video output 1140. The merged first camera video output 1140 can overlay output from a second camera video output 1130 rendering a picture-in-picture display on the first device. The composite video created by merging the first camera video output 1140 with the second camera video output 1150 can be viewed on the first mobile device 1110 and shared with a second mobile device. In some embodiments, the sharing can be accomplished using a website or a mobile application.

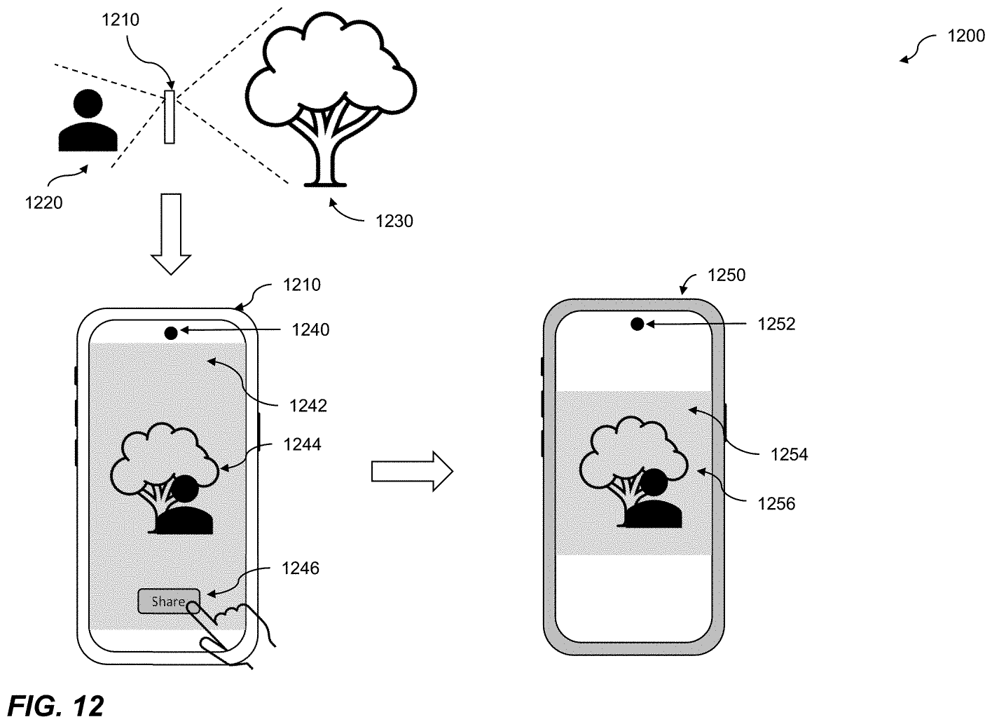

FIG. 12 is an example 1200 of sharing with real-time video overlaying and sharing. As discussed above and throughout, video output can be captured from a first camera 1240 on a first mobile device 1210. A portion of an individual 1220 can be detected and recognized in the video output that was captured, and a user body contour of the individual 1220 can be determined. A binary mask can be generated, enabling real-time video processing, which includes separating the user body contour from a background of the video output from the first camera. The user body contour can be separated from the background using a depth sensor on the first mobile device to determine a first distance from the first camera 1240 to the face of the individual 1220 using the first mobile device 1210. A cutoff depth can be used to determine the maximum distance from the first camera 1240 to be used in generating a binary mask. The binary mask can be smoothed and merged into the first camera video output. The merged first camera video output can overlay output from a second camera video output 1230. In embodiments, the second camera can be included on the first mobile device 1210, wherein the first camera and second camera are facing in opposite directions. The merged output from the first camera video 1220 and the binary mask can be combined with the video captured from a second camera 1230 to create a composite video 1244. The composite video 1244 can be viewed 1242 on the first mobile device 1210 and shared 1246 with a second mobile device 1250. The second mobile device 1250 can view 1256 the composite video 1254 comprised of the merged video output 1254 from the first camera on the first mobile device 1220 with the video output from a second camera 1252 on the first mobile device 1230. In some embodiments, the sharing can be accomplished using a website or a mobile application.

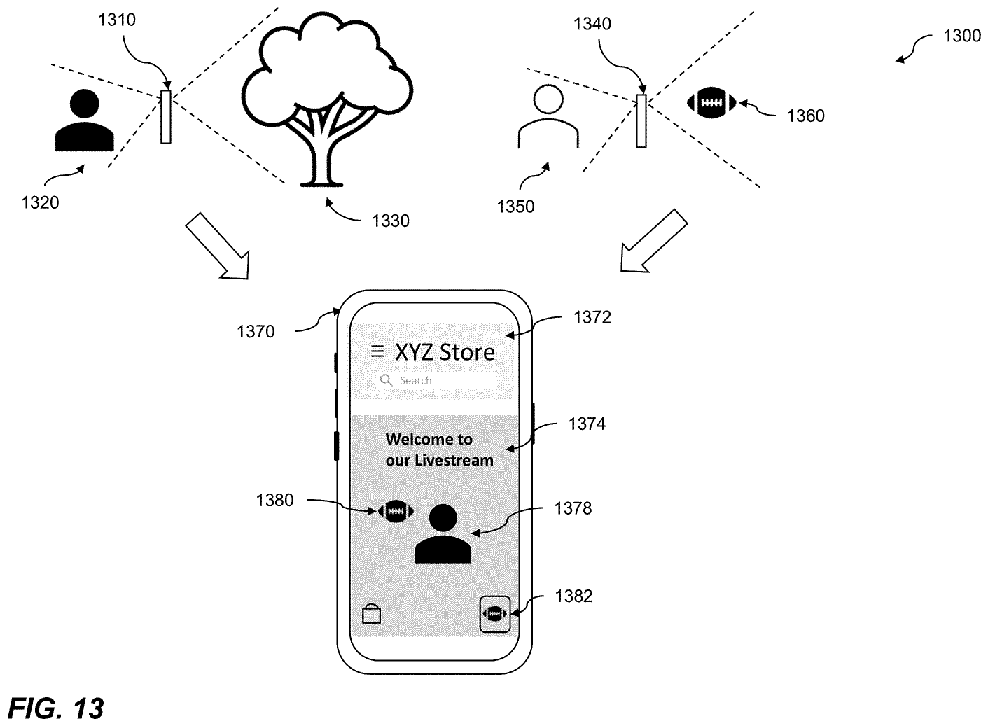

FIG. 13 is an example 1300 of a livestream with video output from a second camera on a second mobile device. As discussed above and throughout, video output 1320 can be captured from a first camera on a first mobile device 1310. A portion of an individual can be detected and recognized in the video output 1320 that was captured, and a user body contour of the individual can be determined. A binary mask can be generated, enabling real-time video processing, which includes separating the user body contour from a background of the video output from the first camera 1310. The user body contour can be separated from the background using a depth sensor on the first mobile device to determine a first distance from the first camera to the face of the individual using the first mobile device 1310. A cutoff depth can be used to determine the maximum distance from the first camera to be used in generating a binary mask. The binary mask can be smoothed and merged into the first camera video output 1320 to create a composite video 1378. In some embodiments, a second camera can be included on a first mobile device 1310. The first camera and the second camera on the first mobile device 1310 can face in opposite directions. The video output from the second camera 1330 on the first mobile device can be omitted from the composite video 1378. The composite video 1378 created from the first camera on the first mobile device 1310 can be shared with a second mobile device 1370. In some embodiments, the sharing can be accomplished using a website or a mobile application. The composite video 1378 from the first camera can be included in a livestream event 1374.

In embodiments, video output 1360 can be captured from a second camera on a second mobile device 1340. The video output from the second camera can include at least one product for sale. The at least one product for sale can be detected and recognized in the video output 1360 that was captured. In some embodiments, the recognizing can be accomplished by machine learning. A binary mask can be generated, enabling real-time video processing, which includes separating the at least one product for sale from a background of the video output from the second camera 1340. The contour of the at least one product for sale can be separated from the background using a depth sensor on the second mobile device 1340 to determine a first distance from the second camera to the surface of the at least one product for sale closest to the second camera. A cutoff depth can be used to determine the maximum distance from the second camera to be used in generating a binary mask. The binary mask can be smoothed and merged into the second camera video output 1360 to create a composite video 1380. In some embodiments, a first camera can be included on a second mobile device 1350. The first camera and the second camera on the second mobile device 1340 can face in opposite directions. The video output from the second camera 1360 on the first mobile device can be omitted from the composite video 1380. The composite video 1380 created from the camera on the mobile device 1340 can be shared with a second mobile device 1370. The sharing can be accomplished using a website or a mobile application. The composite video 1380 from the second camera can be included in a livestream event 1374. In some embodiments, the livestream event 1374 can be hosted by an ecommerce vendor 1372. Ecommerce purchasing of the at least one product for sale can be accomplished within the livestream window. A product card 1382 can be pinned in the livestream window 1374 using one or more processors, representing the at least one product for sale 1380. Thus, an individual 1320 using a first camera on a first mobile device 1310 can act as an influencer or presenter of at least one product for sale 1360 captured in a real-time video using a second camera on a second mobile device 1340. The composite videos 1378 and 1380 created from mobile device 1310 and mobile device 1340 can be included in a livestream event 1374 and presented to a second mobile device 1370. The livestream event 1374 can be hosted by an ecommerce vendor 1372. The livestream window 1374 can include a product card 1382, enabling an ecommerce purchase of at least one product for sale by a viewer of the livestream event. In some embodiments, the livestream window 1374 can present a coupon overlay to the viewer.

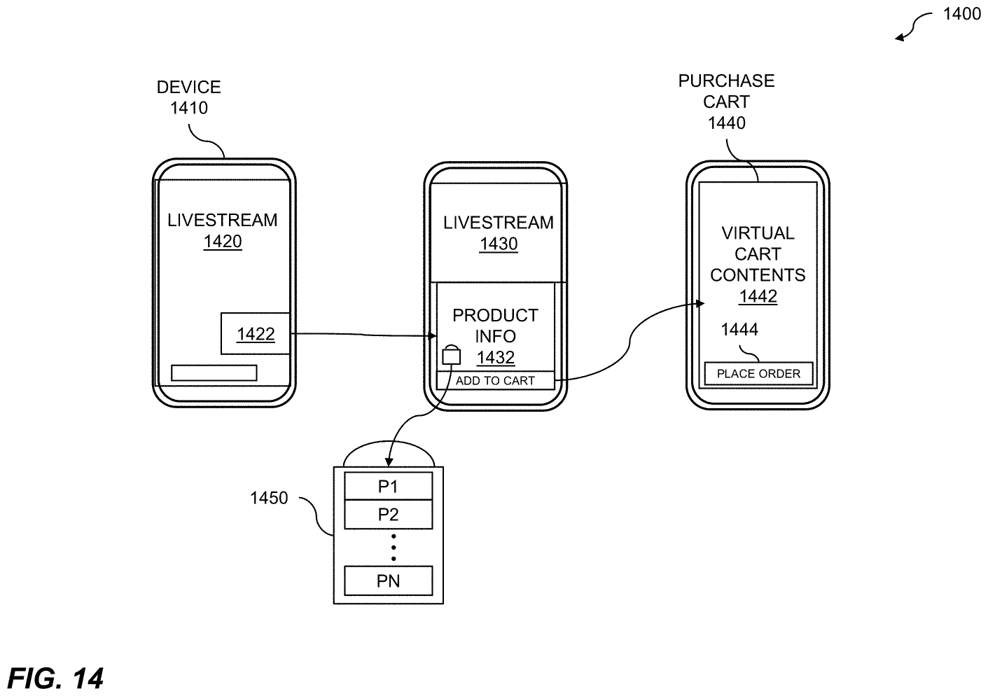

FIG. 14 is an infographic 1400 for an ecommerce checkout in a multi-host livestream. As described above in FIG. 13 and throughout, video output from a first camera on a first mobile device can be captured and used to create a composite video which can be used in a livestream event 1420. In some embodiments, video output from a second camera can be captured and combined with video output from a first camera on a first mobile device to create a composite video. The second camera can be included on the first mobile device and can be facing in the opposite direction from the first camera, or the second camera can be included on a second mobile device. The video output from the second mobile device can be combined with the video output from the first mobile device to create a composite video 1422 which can be included in a livestream event 1420. The livestream event 1420 can be viewed on a mobile device 1410. The composite video 1422 can include video output from the second camera that can incorporate at least one product for sale. The at least one product for sale can be recognized from a library of products for sale 1450. In some embodiments, the recognizing can be accomplished using machine learning. The composite video 1422 can include pinning a product card 1432, using one or more processors, into the livestream event window 1430, wherein the product card represents the at least one product for sale. The product card 1432 can include product information about the at least one product for sale. In some embodiments, the product card 1432 can include a purchase cart 1440 that can be used to enable an ecommerce purchase of at least one product for sale. The purchase cart 1440 can present the contents 1442 of one or more products for sale selected by a user during a livestream event 1420. The viewer of the livestream event 1420 can place an order 1444 to purchase the one or more products selected.

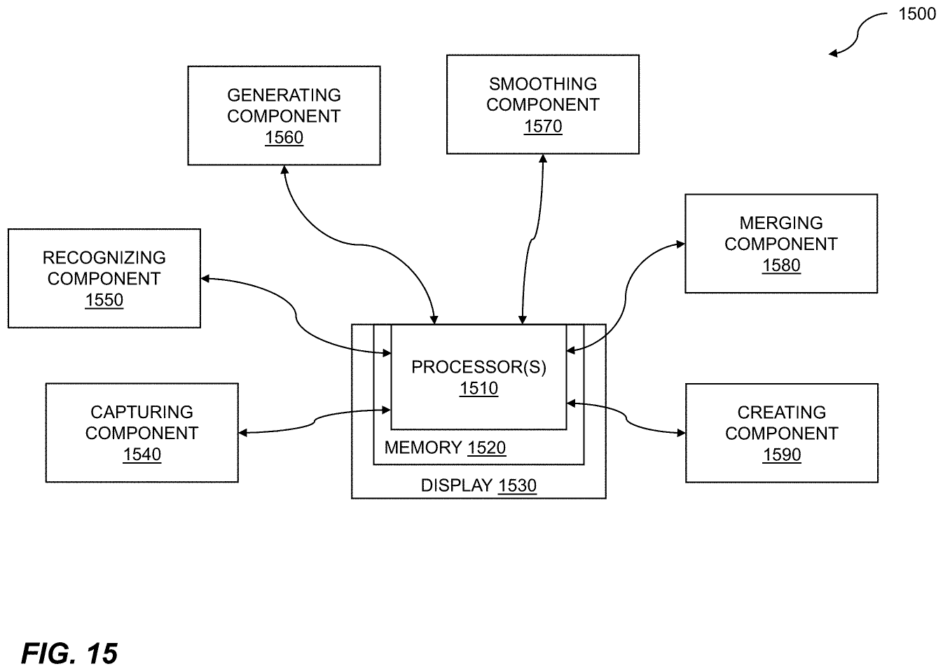

FIG. 15 is a system diagram for overlaying. Individuals and businesses are seeking tools giving greater flexibility in real-time video generation, editing, and combining streams from multiple sources to produce finished products for sales and marketing, education, influencing, and other applications. Livestream events make the demand for combining and refining video streams from multiple cameras even greater. The opportunities to market products and services continue to grow as influencers from locations across the country or across the globe participate in events in real time. Vendors or athletes can highlight products as they are being used in sporting events, fashion designers can comment on clothing as they come down a runway or appear on the street, and so on. Video captured from a mobile device held in a hand or worn can isolate the individual appearing in the video from the background and combine him or her with video generated from a second camera. The second camera can be a part of the same mobile device that contains the first camera or can be included on a second mobile device across the street or in another part of the world entirely. Video effects can be used on presenters appearing in the video streams from a first camera, products for sale on a second camera, or both in order to highlight the elements the user deems most important. The first camera video can be resized and moved to a different part of the video frame and smoothed so that, when combined with the video from a second camera, the viewer sees only a seamless single presentation. Product information can be added to the combined video stream so that ecommerce opportunities to purchase items as they appear in a livestream event or recorded presentation are immediately available. The system 1500 can include one or more processors 1510 and a memory 1520 which stores instructions. The memory 1520 is coupled to the one or more processors 1510, wherein the one or more processors 1510 can execute instructions in the memory 1520. The memory 1520 can be used for storing instructions, one or more images, depth data, binary mask calculations, gamma adjustment calculations, and the like. Information associated with image analysis, smoothing processes, etc., can be shown on a display 1530 connected to the one or more processors 1510. The display can comprise a computer monitor (including a laptop screen, a tablet screen, a netbook screen, and the like), a smartphone display, a mobile device, or another electronic display.

The system 1500 can include a capturing component 1540. The capturing component 1540 can be used to capture video output from a first camera on a first mobile device. The captured video output from the first camera can be displayed on the first mobile device. In some embodiments, the capturing component 1540 can be used to capture video output from a second camera on a first mobile device. The captured video output from the second camera can be displayed on the first mobile device. The first camera and the second camera can be facing opposite directions. In some embodiments, the first camera and the second camera can be included on a wearable device. The capturing component 1540 can be used to capture an image from a composite video created by the creating component 1590. The captured image can be displayed in an application running on the first mobile device and shared with a second mobile device. The sharing can be accomplished using a website or a mobile application.

The system 1500 can include a recognizing component 1550. The recognizing component 1550 can be used to recognize a portion of an individual in the video output that was captured from a first camera, wherein the recognizing determines a user body contour. In some embodiments, the recognizing of a portion of an individual can be based on machine learning.

The system 1500 can include a generating component 1560. The generating component 1560 can be used to generate a binary mask, wherein the binary mask enables real-time video processing, which includes separating the user body contour from a background of the video output from the first camera. The generating component can be used to synchronize frame rates of depth data, face metadata, and video data of the first camera. A depth sensor included on a first mobile device can be used to determine a first depth between a user face and the first camera. A cutoff depth can be used to determine the user body contour. Objects that appear in the video frame of the first camera video that are determined by a depth sensor to be between the first depth and the cutoff depth can be used to determine the user body contour and to generate a binary mask. The generating component 1560 can be used to apply a low pass filter on the binary mask. A low pass filter can be used to filter out high frequency noise or unwanted signals that may be captured within a video frame. A cutoff frequency level is used to mark which lower frequency signals are retained while higher frequencies are rejected. The result is that the video image is slightly blurred, more accurately resembling the object to the human eye. The binary mask can temporarily buffer a last binary mask that corresponds to a last frame from the first camera video in the memory 1520. The last binary mask can be mixed with a current binary mask that corresponds to a current frame, wherein the binary mask is based on a combination of the last frame and the current frame.

The system 1500 can include a smoothing component 1570. The smoothing component 1570 can be used to smooth one or more edges of the binary mask. The smoothing component 1570 can be used to create an alpha matte on the binary mask. An alpha matte is a video clip or image which is used to create a transparency layer for another video clip. When used in combination with the binary mask and the first camera video, the only visible portion of the first camera video is that which is within the binary mask and alpha matte—the visible face and body of the individual contained in the foreground of the first camera video. The smoothing component 1570 can be used to upscale the alpha matte to RGB resolution. The smoothing component 1570 can be used to create a second alpha matte on the video output of the first camera. The second alpha matte can be used to correct an orientation of the video output from the first camera. The smoothing component 1570 can be used to apply a gamma adjust process and a gaussian blur process to one or more edges of a binary mask. The smoothing component 1570 can be used to transform the binary mask to allow a drag-and-zoom feature. The zoom feature can be used to scale the binary mask to the same size as the video output from the second camera. The scaling can be done in response to a user gesture. The drag feature can be used to place the binary mask at a position corresponding to apportion of the video output from the second camera. The smoothing component 1570 can be used to smooth a first camera video output that comprises a selfie video. The smoothed selfie video can be shared with a second mobile device and overlaid with a second selfie video captured by a second mobile device.

The system 1500 can include a merging component 1580. The merging component 1580 can be used to merge the binary mask with the video output from the first camera, wherein the merging produces a merged first camera video output. The merging component 1580 can be used to merge a video effect overlay, selected by a user from a library of video effects, with the merged first camera video output. Video effects can include backgrounds, illustrations, transitions, moving letters, etc.

The system 1500 can include a creating component 1590. The creating component 1590 can be used to create a composite video, wherein the merged first camera video output is overlaid onto a video output from a second camera. The merged first camera video output overlaid on the video output from the second camera can render a picture-in-picture display on the first mobile device. The composite video can be displayed in an application running on the first mobile device. The composite video can be scaled in response to a user gesture. The creating component 1590 can be used to share the composite video with a second mobile device. The sharing can be accomplished using a website or a mobile application. The creating component 1590 can be used to create a composite video to be included in a livestream event. The creating component 1590 can be used to enable an ecommerce purchase of at least one product for sale by a viewer, wherein the ecommerce purchase is accomplished within a livestream window. The creating component 1590 can be used to create a composite video wherein the video output from the second camera includes at least one product for sale. The at least one product for sale can be recognized from a library of products for sale. In some embodiments, the recognizing can be accomplished by machine learning. The creating component 1590 can be used to pin a product card, using one or more processors 1510, in the livestream window, wherein the product card represents the at least one product for sale. The creating component 1590 can be used to present a coupon overlay to the viewer of the livestream window.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first column could be termed a second column, and, similarly, a second column could be termed the first column, without changing the meaning of the description, so long as all occurrences of the “first column” are renamed consistently and all occurrences of the “second column” are renamed consistently. The first column and the second are columns both column s, but they are not the same column.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for the purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described.

While the invention has been disclosed in connection with preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A computer-implemented method for video content analysis comprising:
capturing video output from a first camera on a first mobile device;
recognizing a portion of an individual, in the video output that was captured, wherein the recognizing determines a user body contour;
generating a binary mask, wherein the binary mask enables real-time video processing, which includes separating the user body contour from a background of the video output from the first camera;
smoothing one or more edges of the binary mask;
merging the binary mask with the video output from the first camera, wherein the merging produces a merged first camera video output; and
creating a composite video, wherein the merged first camera video output is overlaid onto a video output from a second camera.

2. The method of claim 1 wherein the first camera and the second camera are included on the first mobile device.

3. The method of claim 2 wherein the first camera and the second camera are facing in opposite directions.

4. The method of claim 3 wherein the video output from the first camera and the video output from the second camera are displayed on the first mobile device.

5. The method of claim 4 further comprising rendering a picture-in-picture display, on the first mobile device, wherein the merged first camera video output is overlaid on the video output from the second camera.

6. The method of claim 3 further comprising sharing the composite video with a second mobile device.

7. The method of claim 6 further comprising selecting, by a user, a video effect overlay from a library of video effect overlays.

8. The method of claim 7 further comprising merging the video effect overlay with the merged first camera video output.

9. The method of claim 1 wherein the video output from the second camera comprises video output from a camera on a second mobile device.

10. The method of claim 9 wherein the composite video is included in a livestream event.

11. The method of claim 10 further comprising enabling an ecommerce purchase of at least one product for sale by a viewer, wherein the ecommerce purchase is accomplished within a livestream window.

12. The method of claim 11 wherein the video output from the second camera includes the at least one product for sale.

13. The method of claim 12 further comprising recognizing the at least one product for sale from a library of products.

14. The method of claim 11 further comprising pinning a product card, using one or more processors, in the livestream window, wherein the product card represents the at least one product for sale.

15. The method of claim 1 wherein the composite video is scaled in response to a user gesture.

16. The method of claim 1 wherein the video output from the first camera comprises a smoothed selfie video.

17. The method of claim 16 wherein the smoothed selfie video is shared with a second mobile device.

18. The method of claim 17 wherein the smoothed selfie video is overlaid with a second selfie video captured by the second mobile device.

19. The method of claim 1 further comprising synchronizing frame rates of depth data, face metadata, and video data of the first camera.

20. The method of claim 19 further comprising determining a first depth between a user face and the first camera.

21. The method of claim 20 further comprising using a cutoff depth to determine the user body contour.

22. The method of claim 21 wherein the generating the binary mask is based on the first depth and the cutoff depth.

23. The method of claim 19 wherein the depth data is determined by a depth sensor.

24. The method of claim 1 further comprising employing a second alpha matte on the video output from the first camera.

25. The method of claim 24 further comprising correcting an orientation of the video output from the first camera.

26. The method of claim 25 further comprising combining the video output from the first camera with the binary mask.

27. A computer program product embodied in a non-transitory computer readable medium for machine learning, the computer program product comprising code which causes one or more processors to perform operations of:
capturing video output from a first camera on a first mobile device;
recognizing a portion of an individual, in the video output that was captured, wherein the recognizing determines a user body contour;
generating a binary mask, wherein the binary mask enables real-time video processing, which includes separating the user body contour from a background of the video output from the first camera;
smoothing one or more edges of the binary mask;
merging the binary mask with the video output from the first camera, wherein the merging produces a merged first camera video output; and
creating a composite video, wherein the merged first camera video output is overlaid onto a video output from a second camera.

28. A computer system for machine learning comprising: a memory which stores instructions;
one or more processors attached to the memory wherein the one or more processors, when executing the instructions which are stored, are configured to:
capture video output from a first camera on a first mobile device;
recognize a portion of an individual, in the video output that was captured, wherein recognizing determines a user body contour;
generate a binary mask, wherein the binary mask enables real-time video processing, which includes separating the user body contour from a background of the video output from the first camera;
smooth one or more edges of the binary mask;
merge the binary mask with the video output from the first camera, wherein merging produces a merged first camera video output; and
create a composite video, wherein the merged first camera video output is overlaid onto a video output from a second camera.
